(19) United States
(12) Patent Application Publication
(10) Pub. No.: US 2005/0086071 A1
(43) Pub. Date: Apr. 21, 2005

(54) System and method for managing patient care

(76) Inventors: Charles S. Fox JR., Leawood, KS (US); Thomas Fangman, Shawnee, KS (US); Nelson Holton, Boulder, CO (US); Ray Jones, Longmont, CO (US); Greg Meyer, Smithville, MO (US)

Correspondence Address: SHOOK, HARDY & BACON L.L.P., 2555 GRAND BOULEVARD, KANSAS CITY, MO, 64108-2613, US

(21) Appl. No.: 10/684,820

(22) Filed: Oct. 15, 2003

(51) Int. Cl. G06F 17/60

(52) U.S. Cl. 705/2

(57) ABSTRACT

The present invention is directed to a method and system for managing patient care. The system may include a central information system containing patient records, caregiver data, and task-related information. The system may additionally include a patient identification device including a patient identifier linking a patient to a patient record in the central information system and a caregiver identifier associated with the caregiver data in the central information system. The system may further include a portable information device for collecting data from the patient identification device and communicating with the central information system to retrieve the patient record and verify the caregiver identifier. The system may further include a device link server and a patient link micro-server for locally caching data. Other identification devices such as a medication identification device and a medical device identifier may also be provided in the system.

### CROSS-REFERENCE TO RELATED APPLICATIONS

None

### STATEMENT REGARDING FEDERALLY SPONSORED RESEARCH OR DEVELOPMENT

None

### TECHNICAL FIELD

Embodiments of the present invention relate to management of patient care. More particularly, embodiments of the invention are directed to management of patient care directed at maximizing efficiency and minimizing error in an institutional environment.

### BACKGROUND OF THE INVENTION

With the shortage of skilled caregivers and the growing complexity of the healthcare industry, the potential for devastating healthcare errors has increased. Particular risks exist in dispensing of medications in an institutional environment. Mistakes are often made during this process due to the sheer number of constantly changing caregivers, the growing complexity of health care, and opportunities for error. In a hospital environment, post-surgical procedures can be the most dangerous segment of a patient's hospital stay. A large percentage of medication errors occurs in administration of medication due to mistaken patient identification, incorrect medication, or incorrect dosage. Misreading of decimal values for a prescribed dosage is far too common of a phenomenon.

Risks are further increased by errors in specimen testing and collection. Increased nursing workloads can lead to cumulative delays in labeling of specimens. The delays frequently result in inaccurate documentation.

In addition to safety concerns, the healthcare industry is generally managed inefficiently. Caregivers such as nurses look at a set of instructions. The caregivers proceed to gather information by interpreting orders entered in a computer. The caregivers perform ordered procedures, and create records of the procedures. Furthermore, the caregivers generally interpret an order for each patient. Each order contains a set of tasks. While the caregiver may only be performing one task from the order, the caregiver still is required to interpret the entire order. For example, an order may require administration of medication three times a day for three weeks. A task is performed each time medication is administered. To determine if a task should be performed, the caregiver must check the frequency and duration of the order to determine if action is required. These procedures involve an excessive number of steps and increase the potential for error.

Systems have been developed for managing medication administration, but suffer from various deficiencies. U.S. patent Publication US 2002/0038392 to De La Huerga discloses a method and apparatus for controlling IV delivery and monitoring. The apparatus includes a patient device for storing patient information and a caregiver device for storing caregiver information. The caregiver uses the caregiver device to read the patient identifier to determine if a delivered medication is appropriate. This system does not allow for real time updating of patient information for multiple patients simultaneously. The system further does not provide real-time order changes to caregivers. Furthermore, the system is not centrally managed.

A solution is needed for managing healthcare that is both safe and efficient. The processes and components of the solution should drive care activities that are safe, consistent with a plan of care, properly documented and recorded, and protected from failure of primary systems at all times. The solution should further cause caregivers to become more productive and should protect patients.

### BRIEF SUMMARY OF THE INVENTION

In one aspect, the present invention is directed to a system for managing patient care. The system includes a central information system containing patient records and task-related information. The system additionally includes a patient identification device including a patient identifier linking a patient to a patient record in the central information system. The system further includes a portable information device for collecting data from the patient identification device and communicating with the central information system to retrieve the patient record.

In a further aspect, the invention includes a system for managing patient care that includes a patient identification device having indicia identifying a patient, a caregiver identification device providing indicia identifying a caregiver, and a device identification component containing indicia identifying a medical device. The system may further include a device link server for caching information regarding procedures performed with the identified medical device on an identified patient by an identified caregiver. The system may also include a portable information device for providing the identified caregiver with information from the device link server and for transmitting information to the device link server.

In yet a further aspect, the invention may include a method for providing patient care using a system incorporating a patient identifier, a portable information device, and a central information system. The method may include obtaining the patient identifier with the portable information device and transmitting the patient identifier from the portable information device to the central information system. The method may further include receiving current patient related tasks from the central information system at the portable information device.

In yet a further aspect, a method is provided for managing patient care using a patient identification device including a patient identifier, a caregiver identification device including a caregiver identifier, a patient link server, a portable information device, and a medical device identification device including a medical device identifier. The method includes processing the patient identifier, the caregiver identifier, and the medical device identifier using the portable information device and prompting the identified caregiver to perform at least one ordered task on the identified patient in accordance with instructions provided through the personal information device using the identified medical device. The method additionally includes transferring information pertaining to a performed task from the portable information device to the patient link server and caching the transferred information on the patient link server.

In yet an additional aspect, a system is provided for managing patient care. The system includes a patient identification device providing indicia identifying a patient, a caregiver identification device providing indicia identifying a caregiver, and a patient link server for caching information regarding actions performed with respect to the identified patient, wherein the actions are associated with an identified caregiver. The system additionally includes a portable information device for providing the identified caregiver with information from the patient link server and for transmitting information to the patient link server.

In a further aspect of the invention, a method is provided for managing patient care using a patient identification device including a patient identifier, a caregiver identification device including a caregiver identifier, a device identification device including a device identifier, a portable information device, and at least one of a device link server and a patient link server. The method includes processing the patient identifier, the caregiver identifier, and the device identifier using the portable information device. The method additionally includes prompting the identified caregiver to perform at least one ordered task on the identified patient in accordance with instructions provided through the personal information device using the identified medical device, and transferring information pertaining to a performed task from the portable information device to at least one of the device link server and the patient link server.

### BRIEF DESCRIPTION OF THE DRAWINGS

The present invention is described in detail below with reference to the attached drawing figures, wherein:

FIG. 1 is a block diagram illustrating components of a system for managing patient care in accordance with an embodiment of the invention;

FIG. 2 is a block diagram illustrating components of a system for managing patient care in accordance with an alternative embodiment of the invention;

FIG. 3 is a block diagram illustrating components of a central information system in accordance with an embodiment of the invention;

FIG. 4 is a block diagram illustrating a database of the central information system in accordance with an embodiment of the invention;

FIG. 5 is a block diagram illustrating a caregiver portable computing device in accordance with an embodiment of the invention;

FIG. 6 is a diagram illustrating an identification device in accordance with an embodiment of the invention;

FIG. 7 is a block diagram illustrating a device micro-server link in accordance with an embodiment of the invention;

FIG. 8 is a flow chart illustrating a method for using the system in accordance with an embodiment of the invention;

FIG. 9 is a flow chart illustrating a method for setting up a patient room in accordance with an embodiment of the invention;

FIGS. 10A and 10B provide a flow chart illustrating a method for administering a medication in a single patient, multiple device environment in accordance with an embodiment of the invention;

FIG. 11 is a flow chart illustrating various techniques for using the system in a multi-patient single device environment in accordance with an embodiment of the invention; and

FIG. 12 is a screen shot showing a display of the portable computing device in accordance with an embodiment of the invention.

### DETAILED DESCRIPTION OF THE INVENTION

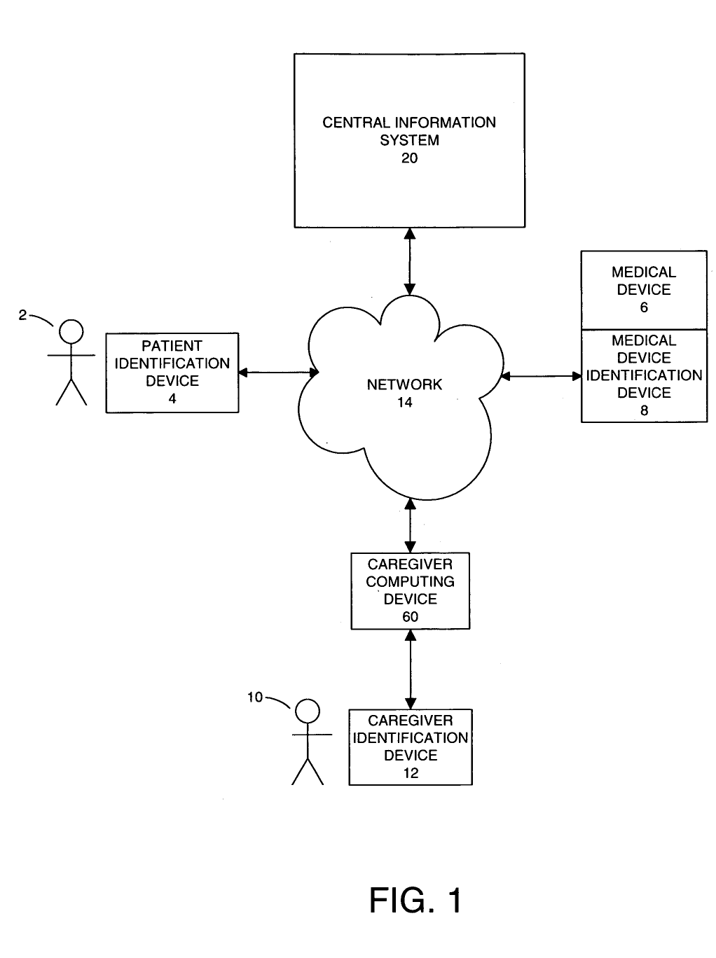

Embodiments of the present invention are directed to a system and method for managing patient care in a safe and efficient manner. Having briefly provided an overview of the present invention, embodiments or the invention will be discussed with reference to FIGS. 1-12.

Specifically, with initial reference to FIG. 1, a patient 2 is identified by a patient identification device 4 and a medical device or medication 6 is identified by a medical device or medication identification device 8. A caregiver identification device 12 may identify a caregiver 10. A central information system 20 and a caregiver portable computing device 60 are capable of communicating over a network 14. The caregiver portable computing device 60 is also capable of processing information from the patient identification device 4, the medical device identification device 8, and the caregiver identification device 12. The caregiver portable computing device 60 can transmit the information to the central information system 20. In this manner, each caregiver 10, each patient 2, and each medication or medical device 6 can be verified with the central information system 20. Each of the components of the system is described in greater detail below. Although all components shown in the embodiment of FIG. 1 communicate with one another over the network, the system components could also be configured to allow peer-to-peer communication in addition to network communication.

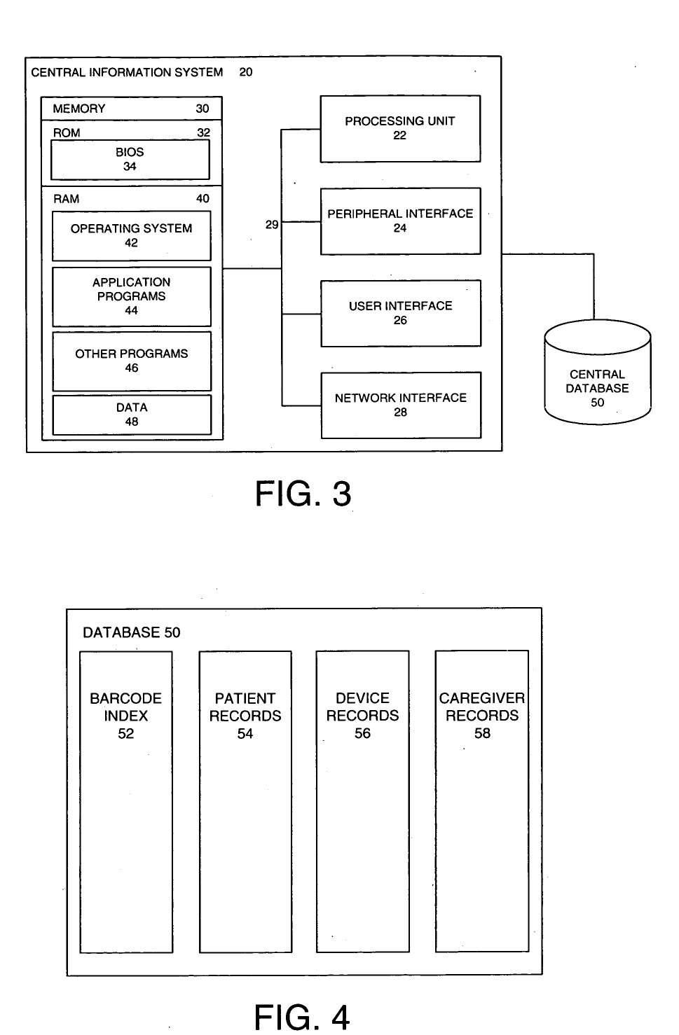

FIG. 3 illustrates an embodiment of the central information system 20. The central information system 20 may include a processing unit 22, a peripheral interface 24, a user interface 20, and a network interface 28. The central information system 20 may also include a memory 30. A system bus 29 couples the aforementioned components. The central information system 20 may also include a central database 50.

The system memory 30 may include computer storage media in the form of volatile and/or nonvolatile memory such as read only memory (ROM) 32 and random access memory (RAM) 40. A basic input/output system 34 (BIOS), containing the basic routines that help to transfer information between elements within the central information system 20, such as during start-up, is typically stored in ROM 32. RAM 40 typically contains data and/or program modules that are immediately accessible to and/or presently being operated on by processing unit 22.

By way of example, and not limitation, FIG. 3 illustrates operating system 42, application programs 44, other program modules 46, and program data 48. The application programs 44 and other programs 46 may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The central information system 20 may also include other removable/non-removable, volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive is typically connected to the system bus through a non-removable memory interface and magnetic disk drive and optical disk drive are typically connected to the system bus by a removable memory interface.

A user may enter commands and information into the central information system through the user interface 26 using input devices such as a keyboard and pointing device, commonly referred to as a mouse, trackball or touch pad. Other input devices may include a microphone, satellite dish, scanner, or the like. These and other input devices are often connected to the processing unit 22 through a user input interface 26 that is coupled to the system bus 29, but may be connected by other interface and bus structures, such as a parallel port or a universal serial bus (USB). A monitor or other type of display device may also be connected to the system bus 29 via an interface, such as the peripheral interface 24. In addition to the monitor, computers may also include other peripheral output devices such as speakers and printer.

The illustrated central information system 20 is merely an example of a suitable environment for the system of the invention and is not intended to suggest any limitation as to the scope of use or functionality of the invention. Neither should the central information system 20 be interpreted as having any dependency or requirement relating to any one or combination of components illustrated.

The central information system 20 in the present invention will operate in a networked environment in conjunction with the network 14 as illustrated in FIG. 1, using logical connections to one or more remote computers, such as the caregiver portable computing device 60. As further described below, the caregiver portable computing device 60 may be a personal computer, and typically includes many of the elements described above relative to the central information system 20.

The network 14 may be the Internet and all components of the system may be accessible over the Internet. Logical connections for networking may include a local area network (LAN) or a wide area network (WAN), but may also include other networks. When used in a LAN networking environment, the central information system 20 may be connected to the LAN through the network interface 28 or adapter. When used in a WAN networking environment, the central information system 20 typically includes a modem or other means for establishing communications, such as the Internet. The modem, which may be internal or external, may be connected to the system bus 29 via the user input interface 26, or other appropriate mechanism.

FIG. 4 illustrates an embodiment of the central database 50 that is a component of the central information system 20. The central database 50 may include an identifier index 52 linking the identifiers to all of the identified patients, devices, medications, and caregivers. In the illustrated embodiment, the identifiers are barcodes, but may be RF identifiers (RFID), or any other machine readable identifiers. Correspondingly, the identifier index 52 is shown as an index of barcodes, but could be an index of RFIDs or other machine readable identifiers. Additionally, the central database 50 may include patient records 54, device records 56, and caregiver records 58. The patient records 54 preferably include each patient's treatment history and orders entered by a physician for treatment of each patient. The device records 56 preferably include device settings and capabilities. The caregiver records 58 preferably include records of assigned tasks for each caregiver in the system. The orders and other information can be accessed through the caregiver portable computing device 60 to determine appropriate tasks to be performed on an identified patient.

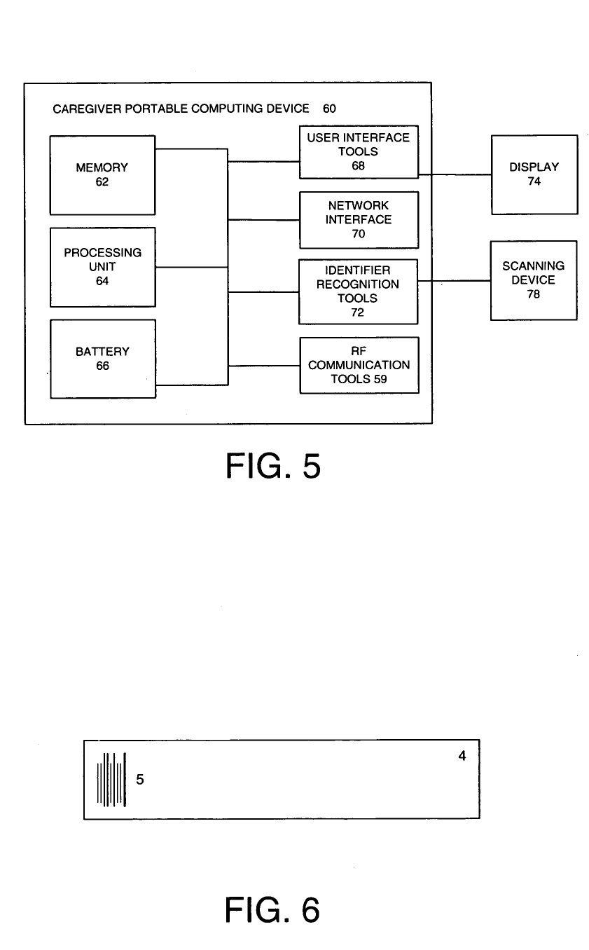

FIG. 5 illustrates an exemplary embodiment of the caregiver portable computing device 60. The caregiver portable computing device 60 may include a memory 62, a processing unit 64, a battery 66, user interface tools 68, network interface 70, RF communication tools 59, and identifier recognition tools 72. The user interface tools 68 may advantageously be accessible through a built-in display device 74. The identifier recognition tools 72 are preferably connecting with a scanning device 78 such as an embedded scanner for scanning barcodes, or other mechanism capable of recognizing RFIDs, or other machine readable identifiers.

In an embodiment of the invention the caregiver portable computing device 60 is a handheld personal digital assistant (PDA). The PDA puts the power of the central database 50 in the caregiver's hands at the point of care. The PDA scans or reads barcodes, RFID, or other machine readable identifiers identified with the patient 2, caregiver 10, devices 6, or procedures. The PDA prompts the caregiver 10 for necessary actions and information during the care-giving process.

The caregiver portable computing device 60 is used as a verification device for reading identifiers from the patient identification device and the caregiver identification device. Caregivers may be provided with varying access levels. For instance, a physician may be able to enter tasks, but some less skilled caregivers may not be permitted such a high access level. In this instance, the caregiver portable computing device 60 is capable of verifying access level through the central database 50 and the caregiver identification device 12.

The caregiver portable computing device 60 accesses the central information system 20 through the network interface 70 and prompts caregivers for scheduled tasks, alerts them to potential error, facilitates documentation, and allows caregivers to review data before posting it to central database. Real time updates and current access orders are available through the caregiver portable computing device 60 in real time.

FIG. 6 illustrates an embodiment of the patient identification device 4 including an identifier 5. The identifier 5 is preferably in the form of a scannable barcode, RFID, or other machine readable identifier. The patient identification device 4 may be in the form of a patient wristband. The caregiver identification device 12 preferably also includes the barcode identifier, RFID, or other machine-readable identifier 5. The caregiver identification device 12 may be affixed to a caregiver badge in an embodiment of the invention. The medical device and medication identification device 8 preferably also includes a barcode identifier, RFID, or other machine readable identifier as shown. The identifiers associated with the patient, caregiver, and device are all preferably linked to specific data within the central information system database 50.

Every apparatus and medication used in medical treatment of a patient may be labeled with an identifier. Anything that can be tagged with an identifier can be monitored by the system of the invention. For instance, an IV bag coming from the pharmacy including medications can be labeled at the pharmacy with an identifier. In practice, the caregiver would scan the labeled medication before adding it to a pump. The labeled medication may be compared with the patient identifier 5 and tasks on record such as patient dose, timing, and pump setting. Since the pump can also be labeled with an identifier, the system, through the caregiver portable computing device 60 looks for an IV pump to associate with the identified IV bag. The physical infrastructure provides a mechanism for scanning a barcode, RFID, or other machine readable identifier that is unique to the IV pump. The tubing attached to the pump and IV bag may also receive an identifier. The system then compares dose, timing, and pump setting with orders on record. In this instance, the caregiver portable computing device 60 could provide a green light if all information matches or an alert if a mismatch occurs. In additional to pumps, any of a number of other medical devices that are attached, inserted, laid upon or otherwise physically associated with a patient may be receive an identifier. These devices include a peripheral IV, a central line, a PA catheter, an arterial line, temporary pacemaker wires, epidural catheters, subdural catheters, endotracheal tubes, chest tubes, surgical drains and urinary catheters and implantable devices such as VP shunts, tracheostomies, cardiac pacemakers, medication pumps, implanted central lines, dialysis shunts and vascular filters. Thus, the attachment type may be identified by the physical connection or the medical device associated with connection. Likewise, the products associated with these devices may also be identified, and may be used similarly to the pump-IV medication combinations described herein.

The contents of manually administered medications may also be labeled with an identifier. Labeling reduces the possibility of a patient receiving incorrect medication or receiving medication at inappropriate intervals or in inappropriate dosages. Collected specimens may also be labeled with identifiers. With the addition of a mobile printer (not shown), specimens can be labeled at the moment of collection, thus further reducing opportunities for error.

Labeling each component with an identifier provides a physical structure to make IV pumps and other medical devices part of the care environment and part of the workflow. If more than one medication, IV bag, or pump is present, the system is capable of distinguishing them from one another because of the aforementioned identifiers.

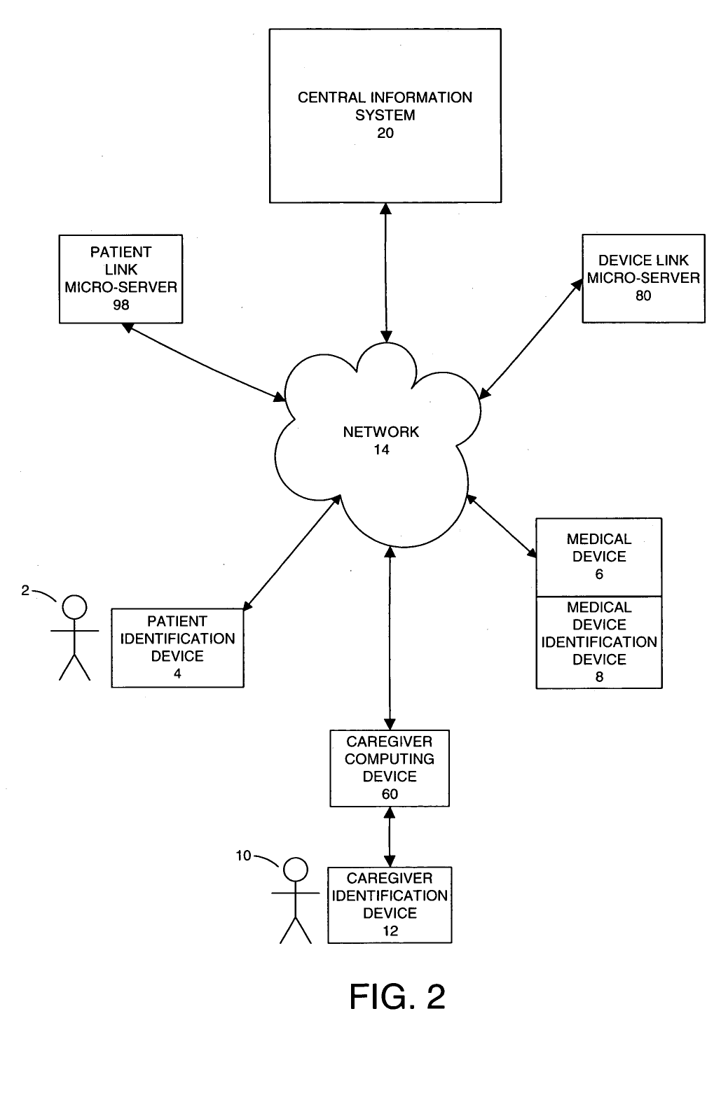

In a second embodiment of the system of the invention as shown in FIG. 2, additional components may be included such as a device link micro-server 80 and a patient link micro-server 98. In implementing the system of the invention, these micro-server components 98 and 80 may both be included or either component 98 or 80 may selectively be implemented. Although all components shown in the embodiment of FIG. 2 communicate with one another over the network, the system components could also be configured to allow peer-to-peer communication in addition to network communication.

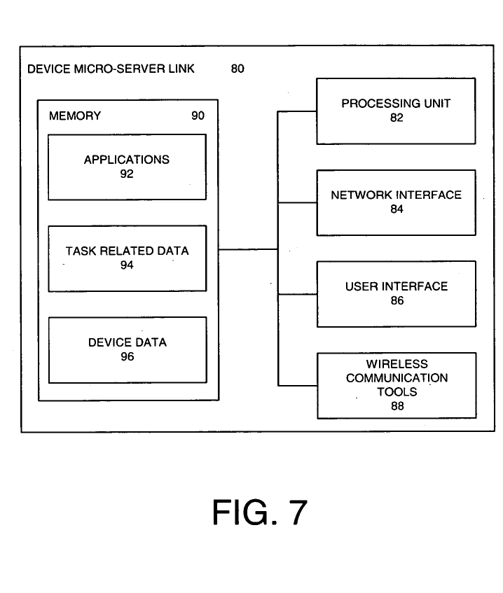

FIG. 7 illustrates an embodiment of the device link micro-server 80. The device link micro-server 80 may include a processing unit 82, a network interface 84, a user interface 86, and wireless communication tools 88. In other embodiments, the device-link micro-server 80 may include hard-wired communication tools. The device link micro-server 80 may also include a memory 90 including applications 92, task related data 94, and device data 96. The device link micro-server 80 has a device driver within its applications 92 and is capable of determining an appropriate communication protocol for the attached device. The device link micro-server 80 uses standard language protocols to communicate with any device and then converts that information to an appropriate format for user by central information system 20. The device link micro-server 80 enables the caregiver 10 to access data from virtually any medical device having a data port.

The patient link micro-server 98 may be substantially identical in structure to the device link micro-server 80 and performs a similar function. However, the application programs running on the two devices may differ. The patient link micro-server 98 and the device link micro-server 80 provide caching or local storage of data. The infrastructure of the micro-server devices 80 and 98 allows retention of data and management at nursing unit level. Although the system can function without the micro-servers 80 and 98 as exemplified by FIG. 1, it is desirable to provide an offline data store. Data in the micro-servers 80 and 98 may be stored as tagged extensible mark-up language (XML) data.

Both the patient link micro-server 98 and the device link micro-server 80 are capable of functioning as web servers. The patient link micro-server 98 may function as a web server that caches patient authentication and demographic information for a single associated patient, task data generated from physician orders, and limited clinical result information. Through the wireless communication tools 88, the patient link micro-server 98 communicates with the caregiver portable computing device 60 and the central information system 20 as shown in FIG. 2. The patient link micro-server 98 preferably communicates with the central database 50 via XML but may also support HL7 and could be configured to operate using the Cerner Millennium™ architecture of Cerner Corporation of Kansas City, Mo., or in any appropriate manner in the context of the provided central information system 20.

Each patient may be provided with the patient link micro-server 98. The micro-server 98 may be wireless or hardwired or both to the central information system 20 and the caregiver portable computing device 60, but may record and transmit information about one particular patient. The patient link micro-server 98 stores a snapshot of all information about the associated patient, thus providing back-up in case information in the central database 50 becomes inaccessible. The patient link micro-server 98 is capable of functioning as a link between the central database 50 and everything that happens to the patient 2.

Accordingly, the patient link micro-server 98 provides a local, real time, and redundant secondary data store that is specific to the patient. The patient link micro-server 98 is preferably located in the patient room and is connected to the central information system 20 through either a wireless or hardwired connection from the central information system 20. The patient link micro-server 98 receives continuous updates to patient-specific information including patient demographics, results, and planned care activities. The data store is temporary, functions during a single episode of care, and may be automatically flushed of data upon discharge of the patient. Thus, the patient link micro-server 98 and the device link micro-server 80 function as localized web servers with information that the caregiver 10 can query. The caregiver 10 can query any patient link micro-server 98 or any device link micro-server 80 using the caregiver portable computing device 60.

The caregiver portable computing device 60 with the embedded scanner or identifier reading mechanism is preferably capable of communication with the device link micro-server 80 and the patient link micro-server 98 with an RF signal. The patient link micro-server 98 is located in the patient environment and preferably holds the local data store that may be hard attached to a local network but may also communicate to other components via RF signal. The device link micro-server 80 is attached directly to any patient-attached devices and may communicate to other components via RF signal. Both devices can communicate directly with the central information system 20 that supplies primary patient-specific information to the patient link micro-server device 98 while the central information system 20 is available.

Both the patient link micro-server 98 and the device link micro-server 80 may continually cache patient specific data from the caregiver portable computing device 60 and any connected medical devices. The cache of information from the micro-servers 80 and 98 may be available from any authorized web browser. The micro-servers 80 and 98 may be directly accessible via a browser over a wired network or using a direct RF network link to the patient link micro-server embedded RF node or the device link micro-server RF node. For access outside the institutional firewall, the micro-servers 80 and 98 may support appropriate encryption schemes. Accordingly, the system continues to support and record care activities even during database downtime because access to the data cached in the micro-servers 80 and 98 via a web browser independent of the primary information system is still available.

The micro-servers 80 and 98 are capable of functioning continuously during downtime of the central information system 20 and have the ability to automatically re-synchronize with the central information system 20 when it becomes available. The patient link micro-server 98 receives updates from the central information system 20 based on design criteria and sends updates to the central information system 20 regarding patient activity and acquired device data. Further, the patient link micro-server 98 stores a record of activity performed at the bedside and any data provided to it by adjacent device link micro-servers 80. In the absence of the central information system 20, the patient link micro-server 98 will continue to check activities against its most current activity list and will queue activity updates and data until the central information system 20 signals its availability to accept those updates.

Additionally, as briefly mentioned above, the patient link micro-server 98 may be designed to communicate directly with multiple, bedside patient-attached devices through the device link micro-server 80. In embodiments of the invention, the patient link micro-server 98 is capable of communicating with up to eight device link micro-servers 80.

Data streaming from patient-attached devices is stored continuously in the patient link micro-servers 98 for access by the caregiver 10. The device link micro-server 80 inherits and supports the full range of commands and functions provided by the device manufacturer for each device attached and operates in conjunction with the patient link micro-server 98 to manage the device 6.

The caregiver portable computing device 60 can be used to configure the patient link micro-server 98. In use, the caregiver portable computing device 60 scans the patient identifier 5, an identifier associated with the patient link micro-server 98, and an identifier associated with the device link micro-server 80. This action initiates a routine in the patient link micro-server 98 that initiates a request to the central information system 20 for all patient-specific demographics, results and activity data for temporary storage in the application server. Devices attached to the device link micro-server 80 become associated to the patient by virtue of their association with the patient-specific patient link micro-server 98.

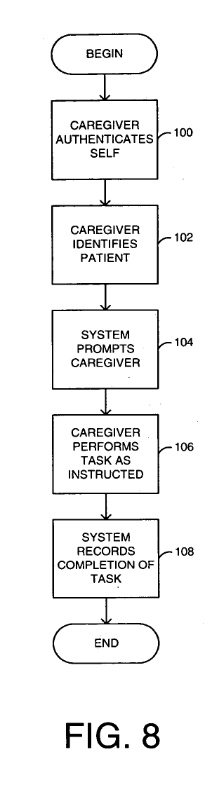

FIG. 8 illustrates an embodiment of a method for using the system described above with reference to FIGS. 1-7. The steps of FIG. 8 are implemented differently depending upon whether the system of FIG. 1 or the system of FIG. 2 is being used. The method of FIG. 8 is described in relation to each of the two systems below.

When using the system of FIG. 1, in step 100, the caregiver 10 performs self-authentication by scanning the caregiver identification device 12 with the caregiver portable computing device 60. As set forth above, this step may involve swiping a barcode, RFID, or other machine readable identifier on the caregiver security badge. This identifies the caregiver and tells the system that the caregiver is authorized to access information about patient. The caregiver portable computing device 60 will obtain verification from the central information system 20.

In step 102, the caregiver 10 authenticates the patient by scanning the patient identification device 4 using the caregiver portable computing device 60. This action identifies the patient by matching the patient identifier with patient records in the central information system 20. The caregiver portable computing device 60 obtains verification and patient information from the central information system 20. In step 104, the caregiver portable computing device 60 prompts the caregiver with a list of patient tasks retrieved from the central information system 20. In step 106, the caregiver performs one or more of the specified tasks. The caregiver can either select a task from the list manually, or can scan a device or medication that she intends to use with the patient to select the task. If all is correct, one click (or other input) sends information to the patient's record. If there is a discrepancy, the system alerts the caregiver by flashing a color code to eliminate the possibility that the problem will be overlooked. In step 108, the system records completion of the task through the caregiver portable computing device 60. The caregiver portable computing device 60 sends information regarding the performed task to the central information system 20.

When using the system of FIG. 2, in step 100, the caregiver 10 performs self-authentication by scanning the caregiver identification device 12 with the caregiver portable computing device 60. In step 102, the caregiver 10 authenticates the patient by scanning the patient identification device 4 using the caregiver portable computing device 60. The patient link micro-server 98 immediately accesses the patient's records to provide assigned tasks during this window of time. The patient link micro-server 98 knows which tasks are due and prompts the caregiver to enter data or confirmation for each one. In step 104, the caregiver portable computing device 60 prompts the caregiver with a list of patient tasks. In step 106, the caregiver performs one or more of the specified tasks. The caregiver can either select a task from the list manually, or can scan a device or medication that she intends to use with the patient to select the task. If all is correct, one click (or other input) sends information to the patient's record in the patient link micro-server 98. If there is a discrepancy, the system alerts the caregiver by flashing a color code to eliminate the possibility that the problem will be overlooked. In step 108, the system records completion of the task through the caregiver portable computing device 60. The patient link micro-server 98 adds the completed task to the patient's record. When the central information system 20 is available, the patient link micro-server 98 provides the recorded information to the central information system 20.

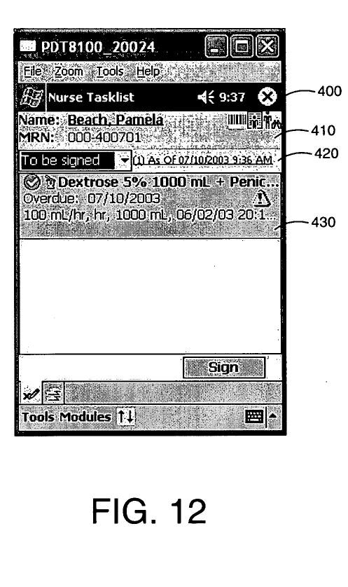

FIG. 12 illustrates a screen display shown on the caregiver portable computing device 60 after step 104 of FIG. 8. A nurse task list 400 appears upon nurse identification. The patient's name and identification number 410 are shown below the task list bar. The date and a drop down menu 420 are shown below the identifying information 410. The task 430 to be completed is also shown.

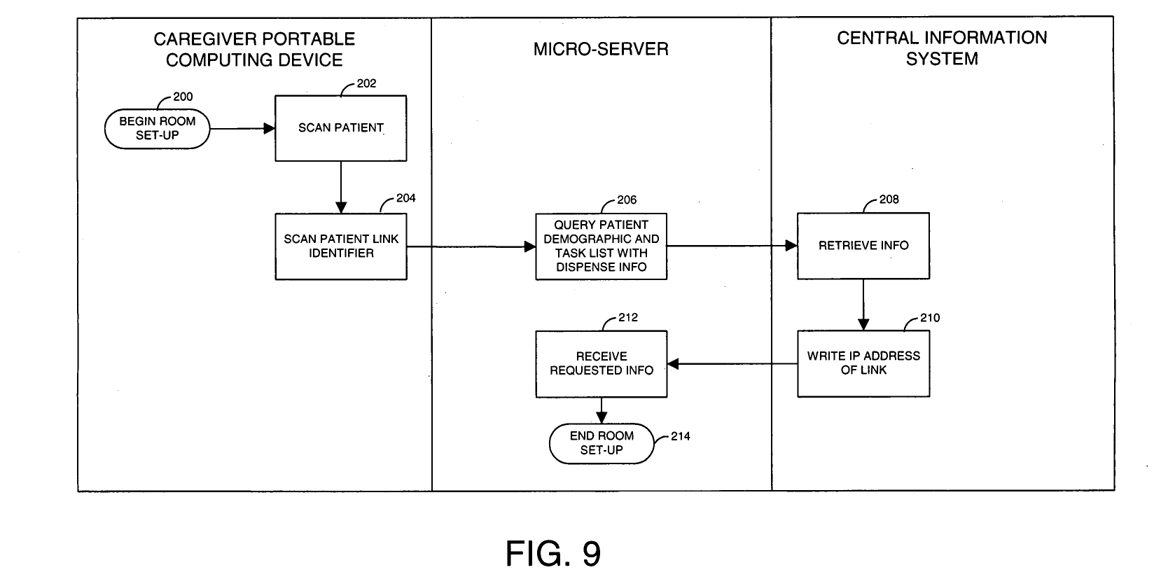

FIG. 9 illustrates a caregiver's interaction with the second embodiment of the system of the invention during initial room set-up. The steps shown in FIG. 9 are only necessary when a patient first arrives in a room and need not be repeated. Using the caregiver portable computing device 60, in step 200, the caregiver begins room set-up. In step 202, the caregiver scans the patient, and in step 204, the caregiver scans the patient link micro-server. In step 206, the patient link micro-server queries the patient demographic and task list that includes dispensing information. In step 208, the information is retrieved from the central information system 20. In step 210, the central information system 20 writes an IP address of the patient link micro-server. In step 212, the patient link micro-server 98 receives the requested information and in step 214, room set-up is ended.

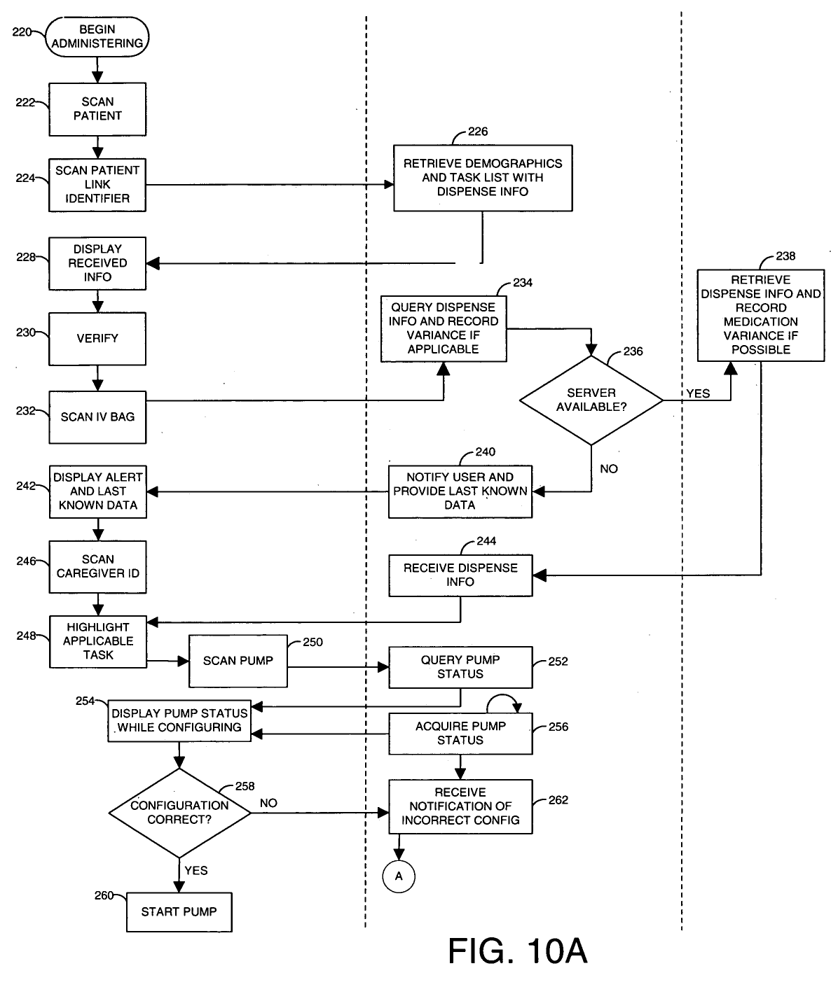

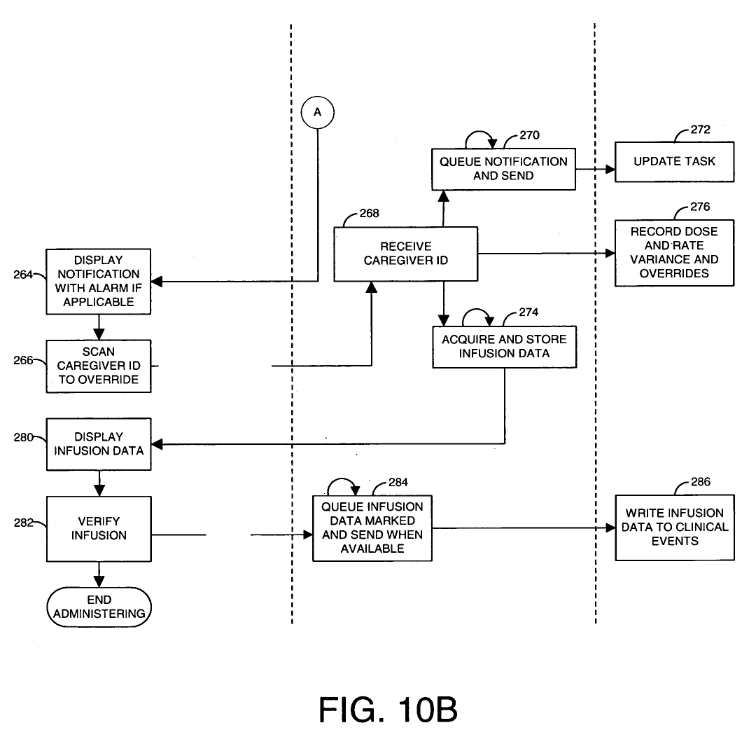

FIGS. 10A and 10B illustrate further details of a method for using the system of the invention in a single-patient multiple device environment. After the room set-up of FIG. 9, the caregiver may begin administering medication in step 220. In step 222, the caregiver scans the patient. In step 224, the caregiver scans the patient link micro-server. In step 226, the patient link micro-server retrieves demographics and a task list with dispensing information. In step 228, the caregiver portable computing device displays received information and verifies the information in step 230. In step 232, the caregiver portable computing device scans an IV Bag (or other consumable). The caregiver portable computing device sends the information to the patient link micro-server to query dispensing information and record variance if applicable in step 234. In step 236, the patient link micro-server determines if the central information system is available.

If the central information system is not available in step 236, the patient link micro-server will provide the last known data to the caregiver portable computing device in step 240. In step 242, the caregiver portable computing device displays an alert and last known data. In step 246, the caregiver scans the caregiver identifier to acknowledge that the last known data is displayed.

If the central information system is available, the patient link micro-server retrieves dispensing information and records medication variance if available in step 238. In step 244, the patient link micro-server receives dispensing information.

After either of steps 244 or 246, the applicable task is highlighted on the caregiver portable computing device. In step 250, the caregiver scans the pump (or other bedside device) and in step 252, the patient link micro-server queries pump status. In step 254, the caregiver portable computing device displays the pump status. If the pump status configuration is not correct in step 256, the caregiver portable computing device sends notification to the patient link micro-server in step 262. If the configuration is correct, the pump starts in step 260.

In FIG. 10B, if the configuration was incorrect, the caregiver portable computing device displays notification with alarm if applicable in step 264. In step 266, the caregiver can scan the caregiver identifier to override. Also, in step 268, the patient link micro-server receives the caregiver ID. In step 270, the patient link micro-server periodically queues and sends notification to the central information system. The central information system updates the task in step 272. In step 268, the patient link micro-server receives the caregiver identifier and the central information system records dose and rate variance and overrides in step 276.

In step 274, the patient link micro-server acquires and stores infusion data (or other data associated with the bedside device). In step 280, the caregiver portable computing device displays infusion data and verifies infusion in step 282. In step 284, the patient link micro-server queues infusion data marked and sends when available. In step 286, the central information system writes infusion data to a clinical events file.

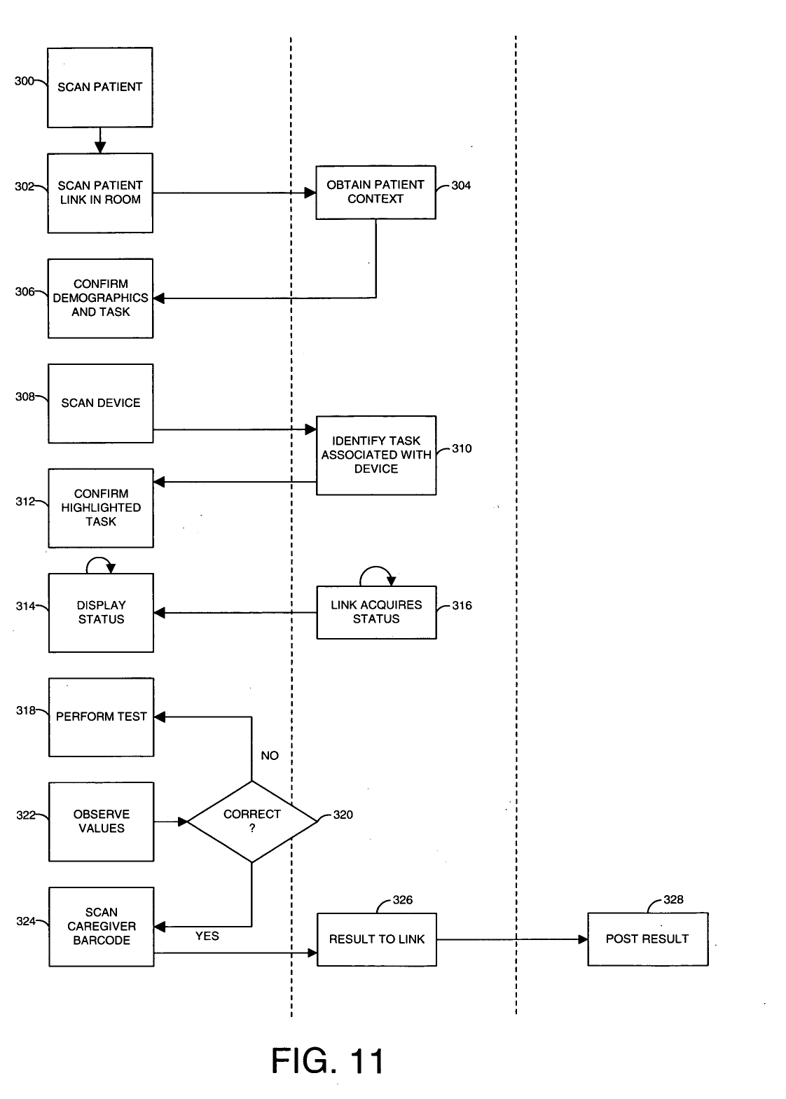

FIG. 11 shows various methods for using the system of the invention in a multi-patient single device environment. In step 300, the caregiver portable computing device scans the patient. The caregiver portable computing device scans the patient link micro-server in step 302. In step 304, the patient link micro-server obtains the patient context. In step 306, the caregiver portable computing device confirms patient demographics and task.

In step 308, the caregiver portable computing device scans the patient link micro-server. In step 310, the patient link micro-server identifies the task associated with the device. In step 312, the caregiver portable computing device confirms the highlighted task.

On an ongoing basis, whenever the patient link micro-server acquires status in step 316, the caregiver portable computing device displays status in step 314.

In step 318, the caregiver performs a test and observes values in step 322. If the values are correct in step 320, the caregiver scans the caregiver barcode, RFID, or other machine readable identifier in step 324, sends the result to the patient link micro-server in step 326 and posts the results to the central information system in step 238.

Using the above-described system and method, all tasks performed with respect to a patient are recorded on the caregiver portable computing device and transmitted to the central information system 20 either through the patient-link server 98 or directly. Caregivers have no opportunity to record data inaccurately as with currently existing systems.

The presently disclosed system is person centric as it is designed to move with patient. The instant identification and access provided by the disclosed system is very important for situations in which documentation is not readily available, such as emergency care. Using network capabilities, a single caregiver can monitor multiple parameters for dozens. The presently disclosed system can be used to help monitor resources and allows less skilled personnel to handle routine tasks. The invention is not limited to use in any particular setting. It can be used in any setting in which multiple patients or caregivers are present.

Additionally, the system provides an extra measure of protection with its built in data redundancy and downtime access. If the central information system is down due to scheduled maintenance, unscheduled electrical failure, or other event, the local devices such as the device link server 80 and the patient link micro-server 98 save all data since the last connection to central information system 20.

The disclosed system is more efficient that currently used systems because it eliminates unnecessary steps. With the disclosed system, a caregiver can receive directions at a patient's bedside by scanning barcodes, RFID, or other machine readable identifiers. The scanning creates the documentation and eliminates the need for an additional processes. Furthermore, since the system uses a central database, even last minute change in orders can be captured. A physician can make adjustments and be certain that caregiver will be alerted in real time. Test results can also be made available as needed and appropriate. The availability of changes to the central information system in real time helps to eliminate errors that occur due to time lag that currently exists.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set for above, together with other advantages, which are obvious and inherent to the system and method. It will be understood that certain features and sub-combinations are of utility and may be employed without reference to other features and sub-combinations. This is contemplated and within the scope of the appended claims.

1. A system for managing patient care, the system comprising:
a central information system containing patient records and task-related information;
a patient identification device including a patient identifier linking a patient to a patient record in the central information system; and
a portable information device for collecting data from the patient identification device and communicating with the central information system to access the patient record.

2. The system of claim 1, wherein the portable information device includes an embedded bar code reader and the patient identification device comprises a machine readable identifier.

3. The system of claim 1, wherein the central information system additionally includes caregiver data.

4. The system of claim 3, further comprising a caregiver identification device including a caregiver identifier associated with the caregiver data in the central information system, wherein the portable information device communicates with the central information system to verify the caregiver identifier.

5. The system of claim 1, further comprising a medication identification device including a machine readable identifier identifying a particular medication, wherein the central information system further comprises medication data.

6. The system of claim 1, further comprising a medical device identification device including a machine readable identifier identifying a particular medical device, wherein the central information system further comprises medical device data.

7. The system of claim 1, further comprising a patient link server device for communicating with the portable information device and for locally caching patient data.

8. The system of claim 7, wherein the patient link server comprises a web server accessible by a web browser to obtain patient information.

9. The system of claim 7, wherein the patient link server includes one of wireless and wired communication tools for communicating with the central information system and the portable information device.

10. The system of claim 1, further comprising a device link server for locally controlling a device.

11. The system of claim 1, wherein the portable information device includes wireless communication tools for communicating wirelessly with the central information system.

12. A system for managing patient care, the system comprising:
a patient identification device providing indicia identifying a patient;
a caregiver identification device providing indicia identifying a caregiver;
a device identification component containing indicia identifying a medical device;
a device link server for caching information regarding actions performed with the identified medical device, wherein the actions are associated with an identified caregiver and an identified patient; and
a portable information device for providing the identified caregiver with information from the device link server and for transmitting information to the device link server.

13. The system of claim 12, wherein the device link server comprises a web server accessible to a web browser for obtaining device information.

14. The system of claim 12, further comprising a patient link server associated with a patient for caching patient data.

15. The system of claim 14, wherein the patient link server comprises a web server accessible by a web browser for obtaining patient information.

16. The system of claim 12, wherein the portable information device includes an embedded bar code reader and the patient identification device comprises a machine readable identifier.

17. The system of claim 12, further comprising a central information system for storing patient data.

18. The system of claim 17, wherein the central information system additionally includes caregiver data.

19. The system of claim 17, further comprising a caregiver identification device including a caregiver identifier associated with the caregiver data in the central information system, wherein the portable information device communicates with the central information system to verify the caregiver identifier.

20. The system of claim 17, further comprising a medication identification device including a bar code identifying a particular medication, wherein the central information system further comprises medication data.

21. The system of claim 17, wherein the central information system further comprises medical device data.

22. The system of claim 14,wherein the patient link server includes at least one of wireless and wired communication tools for communicating with a central information system.

23. The system of claim 12, wherein the portable information device includes wireless communication tools for communicating wirelessly with the device link server.

24. A method for providing patient care using a system including a patient identifier, a portable information device, and a central information system, the method comprising:
retrieving the patient identifier with the portable information device;
transmitting the patient identifier from the portable information device to the central information system; and
receiving current patient related information from the central information system at the portable information device.

25. The method of claim 24, further comprising using the portable information device to obtain a caregiver identifier, transmitting the caregiver identifier from the portable information device to the central information system, and receiving verification of the caregiver identity from the central information system at the portable information device.

26. The method of claim 24, wherein retrieving the patient identifier comprises scanning a machine readable identifier with an embedded scanner in the portable information device.

27. The method of claim 25, wherein obtaining the caregiver identifier comprises scanning a machine readable identifier using an embedded scanner in the portable information device.

28. The method of claim 24, further comprising obtaining a medication identifier from an identification device including a machine readable identifier identifying a particular medication.

29. The method of claim 24, further comprising obtaining a medical device identifier and accessing medical device records from the central information system.

30. The method of claim 24, further comprising recording tasks on a patient link server device by locally caching patient data.

31. The method of claim 30, further comprising accessing information on the patient link server through the use of a web browser.

32. The method of claim 30, further comprising using wireless communication tools for communication between the patient link server and the portable information device.

33. The method of claim 24, further comprising locally controlling a device using a device link server.

34. The method of claim 24, further comprising wirelessly communicating between the personal information device and the central information system.

35. A computer readable medium having computer executable instructions for performing the method of claim 24.

36. A method for managing patient care using a patient identification device including a patient identifier, a caregiver identification device including a caregiver identifier, a device identification device including a device identifier, a patient link server, and a portable information device, the method comprising:
processing the patient identifier, the caregiver identifier, and the device identifier using the portable information device;
prompting the identified caregiver to perform at least one ordered task on the identified patient in accordance with instructions provided through the personal information device using the identified medical device;
transferring information pertaining to a performed task from the portable information device to the patient link server;
and caching the transferred information on the patient link server.

37. The method of claim 36, further comprising accessing data from the patient link server using a web browser.

38. The method of claim 36, further comprising a device link server for storing a record of information coming from the device.

39. The method of claim 38, further comprising accessing the device link server by implementing a web browser.

40. The method of claim 36, further comprising using an embedded scanner in the personal information device to perform patient identification.

41. The method of claim 40, further comprising obtaining patient data from a central information system.

42. The method of claim 41, further comprising obtaining caregiver data from the central information system.

43. The method of claim 36, further comprising wirelessly transferring information pertaining to a performed task from the personal information device to the device link server.

44. A computer readable medium having computer executable instructions for performing the method of claim 36.

45. A system for managing patient care, the system comprising:
a patient identification device providing indicia identifying a patient;
a caregiver identification device providing indicia identifying a caregiver;
a patient link server for caching information regarding actions performed with respect to the identified patient, wherein the actions are associated with an identified caregiver; and
a portable information device for providing the identified caregiver with information from the patient link server and for transmitting information to the patient link server.

46. A method for managing patient care using a patient identification device including a patient identifier, a caregiver identification device including a caregiver identifier, a device identification device including a device identifier, a portable information device, and at least one of a device link server and a patient link server, the method comprising:
processing the patient identifier, the caregiver identifier, and the device identifier using the portable information device;
prompting the identified caregiver to perform at least one ordered task on the identified patient in accordance with instructions provided through the personal information device using the identified medical device; and
transferring information pertaining to a performed task from the portable information device to at least one of the device link server and the patient link server.

47. The method of claim 46, further comprising querying at least one of the device link server and the patient link server to obtain current information.
